(19) United States
(12) Patent Application Publication
(10) Pub. No.: US 2015/0276522 A1
(43) Pub. Date: Oct. 1, 2015

(54) NATURAL-FREQUENCY MEASUREMENT AND BELT-TENSION CALCULATION BASED THEREON

(71) Applicant: BANDO CHEMICAL INDUSTRIES, LTD., Kobe-shi (JP)

(72) Inventors: Hirofumi MIYATA, Hyogo (JP); Yoshikazu WAKIZAKA, Hyogo (JP); Yasushi CHIDA, Hyogo (JP)

(21) Appl. No.: 14/736,360

(22) Filed: Jun. 11, 2015

Related U.S. Application Data
(63) Continuation of application No. PCT/JP2013/007084, filed on Dec. 3, 2013.

(30) Foreign Application Priority Data
Dec. 12, 2012 (JP) 2012-271531

(51) Int. Cl. G01L 5/04

(52) U.S. Cl. CPC G01L 5/042; G01L 5/045

(57) ABSTRACT

The tension of a belt is determined accurately at a low cost. A natural-frequency measurement device is configured to measure, in a belt transmission system including at least two pulleys between which a belt is stretched, the natural frequency of the belt based on a vibration generated by hitting a portion of the belt stretched between two adjacent ones of the at least two pulleys, and includes: an acceleration sensor attached to the portion of the belt to sense acceleration resulting from the vibration of the belt; and a measuring instrument configured to measure the natural frequency of the belt based on the acceleration sensed by the acceleration sensor. The measuring instrument transmits the natural frequency to a belt tension calculator which determines the tension of the belt based on the natural frequency.

### CROSS-REFERENCE TO RELATED APPLICATIONS

This is a continuation of International Application No. PCT/JP2013/007084 filed on Dec. 3, 2013, which claims priority to Japanese Patent Application No. 2012-271531 filed on Dec. 12, 2012. The entire disclosures of these applications are incorporated by reference herein.

### BACKGROUND

The present disclosure relates to a technique for measuring the natural frequency (the frequency of natural vibration) of a belt, a technique for calculating the tension of a belt, and a technique for calculating a natural frequency to adjust the tension of a belt.

If a belt used in a belt transmission system which is stretched between pulleys is not placed under appropriate tension when used, the belt either transmits the rotational forces of the pulleys less efficiently, or shortens the life of the belt. To address this problem, a tension test has been conducted in this field to measure the tension of a belt for use in a belt transmission system and examine whether the belt is placed under appropriate tension.

In carrying out a tension test on a belt, a sonic belt tension measurement device is often used, because the device enables the tester to measure a tension by a simple and non-contact method. A sonic belt tension measurement device includes a natural-frequency measurement device. The natural-frequency measurement device senses, through a microphone, the sound waves produced by vibrations of a belt stretched between pulleys when the belt is hit, and measures the natural frequency of the belt based on the sound waves sensed through the microphone. The sonic belt-tension measurement device is configured to calculate the belt tension, corresponding to the natural frequency measured by the natural-frequency measurement device, according to a predetermined expression (see, for example, Japanese Unexamined Patent Publication No. H06-137932).

### SUMMARY

Unfortunately, such a natural-frequency measurement device that uses a microphone senses sound waves with background noise, which tends to interfere with, and decrease, the accuracy of the natural frequency measured. Such background noise tends to be produced, in particular, in a high frequency range. Thus, if the belt vibration is a high-frequency vibration, the resultant measurement accuracy will be low. On the other hand, a low-frequency vibration of the belt is often difficult to be transformed into sound waves, and thus, can be undetected by a microphone.

For these reasons, such a natural-frequency measurement device using a microphone has a limited range of vibration frequencies, which allows effective and reliable measurements. If the vibration of a belt under measurement has too high a frequency or too low a frequency, accuracy of measurements is not sufficiently high.

Also, in order to calculate the tension of a belt, data on the unit mass of the belt needs to be obtained. There are many kinds of belts such as V belts and synchronous belts, and even one kind of belts include very many types of belts. A memory with a rather large storage capacity needs to be provided to store in advance, for each type of belts, the unit mass, correction data for use when the tension is calculated, and other kinds of data. For this reason, if a single device should perform the process required to measure the tension, the cost of the device would increase.

It is an object of the present invention to measure the natural frequency of a belt accurately over a wide frequency range and determine the tension of the belt accurately at a low cost.

A natural-frequency measurement device according to the present disclosure is a natural-frequency measurement device for measuring, in a belt transmission system including at least two pulleys between which a belt is stretched, a natural frequency of the belt based on a vibration generated by hitting a portion of the belt stretched between two adjacent ones of the at least two pulleys. The device includes: an acceleration sensor attached to the portion of the belt to sense acceleration resulting from the vibration of the belt; and a measuring instrument configured to measure the natural frequency of the belt based on the acceleration sensed by the acceleration sensor. The measuring instrument transmits the natural frequency to a belt-tension calculator which determines a tension of the belt based on the natural frequency.

The device with such a configuration measures the natural frequency of a belt based on the acceleration sensed by an acceleration sensor attached to the belt. This allows the acceleration sensor to sense the vibration of the belt directly. While a non-contact type natural-frequency measurement device including a microphone often allows the measurement results to be interfered by an external environmental factor such as background noise, this direct sensing prevents such interference, and also enables accurate sensing of low-frequency vibration. As such, without regard to whether the vibration of the belt under measurement contains high-frequency components or low-frequency components, the natural frequency of a belt under measurement can be measured accurately. Consequently, the natural frequency of the belt can be accurately measured over a wide frequency range. In addition, the natural frequency is transmitted to the belt-tension calculator, which calculates the tension. A general-purpose calculator can be used as the belt-tension calculator, thus determining the belt tension accurately using a low-cost natural-frequency measurement device.

A non-transitory computer-readable storage medium, according to the present disclosure, contains instructions which, when executed by one or more processors, performs a method for belt-tension calculation, the method including: receiving a span of a belt and the kind or type of the belt; receiving, from a natural-frequency measurement device configured to measure a natural frequency of the belt, the natural frequency; correcting a predetermined expression so that an error caused by a bending stiffness of the belt is reduced if the span falls within a predetermined range corresponding to the belt; determining a tension of the belt, based on the natural frequency, the span, and a unit mass of the belt read from a memory, by using the corrected expression; and displaying the determined tension on a display.

According to such a non-transitory computer-readable storage medium, the natural frequency is received from the natural-frequency measurement device to determine the tension, and therefore, the belt tension can be determined easily. Also, since the tension is determined with a correction process performed so that the error caused by the belt bending stiffness is reduced, the tension can be determined more accurately. The natural-frequency measurement device does not need to perform calculation to determine the tension, and thus, can reduce its costs.

A non-transitory computer-readable storage medium, according to the present disclosure, contains instructions which, when executed by one or more processors, performs a method for belt natural-frequency calculation, the method including: receiving a target tension of a belt, a span of the belt, and the kind or type of the belt; correcting a predetermined expression so that an error caused by a bending stiffness of the belt is reduced if the span falls within a predetermined range corresponding to the belt; determining a target natural frequency of the belt, based on the target tension, the span, and a unit mass of the belt read from a memory, by using the corrected expression; displaying the determined target natural frequency on a display; and transmitting the determined target natural frequency to a natural-frequency measurement device configured to measure a natural frequency of the belt.

According to such a non-transitory computer-readable storage medium, a correction process is performed so that the error caused by the belt bending stiffness is reduced, thus determining a target natural frequency more accurately. The determined target natural frequency is transmitted to the natural-frequency measurement device, which allows the natural-frequency measurement device to display the target natural frequency. Consequently, the belt tension can be adjusted easily. The natural-frequency measurement device does not need to determine the target natural frequency, and therefore, can be a low-cost one.

A method for calculating a tension of a belt, according to the present disclosure, includes: receiving a span of a belt and the kind or type of the belt; receiving, from a natural-frequency measurement device configured to measure a natural frequency of the belt, the natural frequency; correcting a predetermined expression so that an error caused by a bending stiffness of the belt is reduced if the span falls within a predetermined range corresponding to the belt; determining a tension of the belt, based on the natural frequency, the span, and a unit mass of the belt read from a memory, by using the corrected expression; and displaying the determined tension on a display.

According to such a method, the natural frequency is received from the natural-frequency measurement device to determine the tension, and therefore, the belt tension can be determined easily. Also, since the tension is determined with a correction process performed so that the error caused by the belt bending stiffness is reduced, the tension can be determined more accurately. The natural-frequency measurement device does not need to determine the tension, and therefore, can be a low-cost one.

A method for calculating a natural frequency of a belt, according to the present disclosure, includes: receiving a target tension of the belt, a span of the belt, and the kind or type of the belt; correcting a predetermined expression so that an error caused by a bending stiffness of the belt is reduced if the span falls within a predetermined range corresponding to the belt; determining a target natural frequency of the belt, based on the target tension, the span, and a unit mass of the belt read from a memory, by using the corrected expression; displaying the determined target natural frequency on a display; and transmitting the determined target natural frequency to a natural-frequency measurement device configured to measure the natural frequency of the belt.

According to such a method, a correction process is performed so that the error caused by the belt bending stiffness is reduced, thus determining a target natural frequency more accurately. The determined target natural frequency is transmitted to the natural-frequency measurement device, which allows the natural-frequency measurement device to display the target natural frequency. Consequently, the belt tension can be adjusted easily. The natural-frequency measurement device does not need to determine the target natural frequency, and therefore, can be a low-cost one.

According to the present disclosure, the vibration of a belt is sensed by an acceleration sensor directly, and the natural frequency of the belt can be measured accurately over a wide frequency range. Since measurement values and other pieces of information are transmitted between a natural-frequency measurement device and a calculator, the natural-frequency measurement device does not need to perform calculation etc. to determine the tension, and thus, can reduce its costs. Consequently, the tension etc. of a belt can be determined accurately at a low cost.

### BRIEF DESCRIPTION OF THE DRAWINGS

FIG. 1 is a conceptual diagram illustrating a system according to an embodiment of the present invention.

FIG. 2 illustrates an example of a belt transmission system.

FIG. 3 is a block diagram illustrating an exemplary configuration for the natural-frequency measurement device illustrated in FIG. 1.

FIG. 4 is a flowchart showing an exemplary method for measuring the natural frequency of a belt using the natural-frequency measurement device illustrated in FIG. 3.

FIG. 5 is a graph showing an exemplary variation with time in acceleration resulting from a belt's vibration and measured by the natural-frequency measurement device illustrated in FIG. 3.

FIG. 6 shows an exemplary power spectrum determined based on acceleration data in a situation where an acceleration signal was sampled over a relatively long period of time.

FIG. 7 shows an exemplary power spectrum determined based on acceleration data collected by the natural-frequency measurement device illustrated in FIG. 3.

FIG. 8 is a block diagram illustrating an exemplary configuration for the calculator illustrated in FIG. 1.

FIG. 9 is a flowchart showing an exemplary flow of processing to be performed by the calculator illustrated in FIG. 8.

FIG. 10 illustrates an example of a measurement device for determining the relationship between the tension and natural frequency of a belt.

FIG. 11 is a graph showing an exemplary relationship between the span of one type of V belt and the measured tension thereof.

FIG. 12 is a graph showing an exemplary relationship between the span and a coefficient A, and corresponding to the graph shown in FIG. 11.

FIG. 13 is a graph showing an exemplary relationship between the natural frequency f_{S} of a belt determined with the mass of an acceleration sensor taken into account and the theoretical natural frequency f_{T} of the belt.

FIG. 14 is a graph showing an exemplary relationship between the unit mass of a belt and a coefficient B.

FIG. 15 is a flowchart showing an exemplary flow of processing in which tension is adjusted by the calculator illustrated in FIG. 8.

FIG. 16 is a flowchart showing an exemplary flow of processing in which the unit mass and recommended tension of a belt are displayed by the calculator illustrated in FIG. 8.

FIG. 17 is a conceptual diagram illustrating another example of the system illustrated in FIG. 1.

FIG. 18 is a block diagram illustrating an exemplary configuration for the natural-frequency measurement device illustrated in FIG. 17.

### DETAILED DESCRIPTION

An embodiment of the present invention will now be described with reference to the drawings. In the drawings, the same reference characters are used to denote same or similar elements. Solid lines connecting functional blocks in the drawings represent electrical connection between the connected blocks.

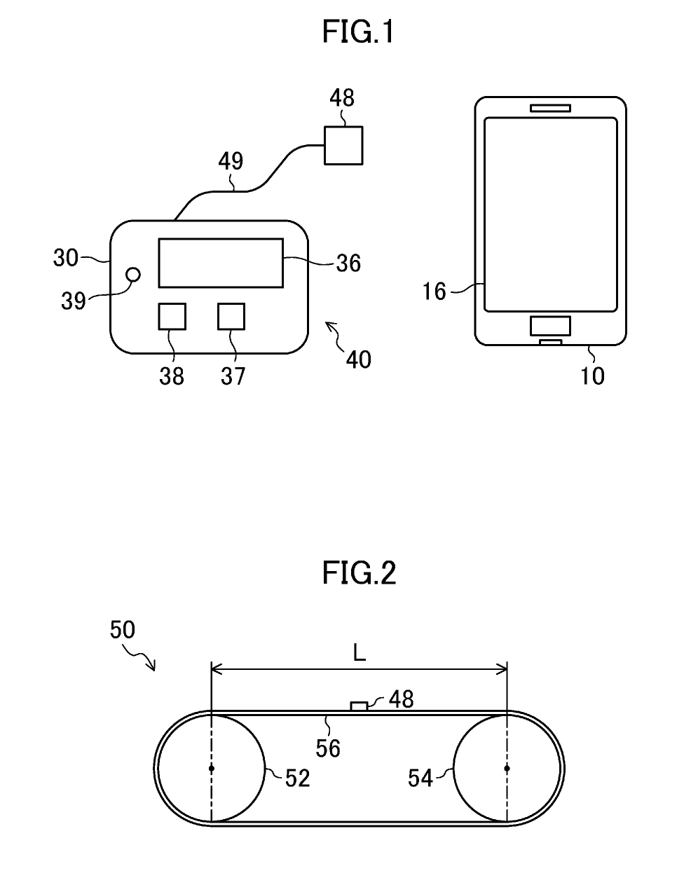

FIG. 1 is a conceptual diagram illustrating a system according to an embodiment of the present invention. The system illustrated in FIG. 1 includes a natural-frequency measurement device 40 and a calculator 10. This system operates basically in the following manner.

The natural-frequency measurement device 40 receives, via a communication cable 49, the vibration of a belt sensed by an acceleration sensor 48 attached to the belt, and determines the natural frequency of the belt with a measuring instrument 30. The measuring instrument 30 transmits the determined natural frequency to the calculator 10 wirelessly, for example. The calculator 10 calculates the tension of the belt based on the received natural frequency, and displays the belt tension calculated. The calculator 10 may further transmit the tension of the belt thus calculated to the measuring instrument 30, which may display the received belt tension in response. Optionally, the calculator 10 may transmit results of any other kind of calculation and other pieces of information to the measuring instrument 30, which may display the received information thereon in response. The communications between the natural-frequency measurement device 40 and the calculator 10 are typically performed wirelessly using radio waves. Specifically, Bluetooth, wireless local area network (LAN) or any suitable technique may be used.

—Natural-Frequency Measurement Device—

FIG. 2 illustrates an example of a belt transmission system 50. The belt transmission system 50 includes at least two (e.g., two in the example shown in FIG. 2) pulleys 52, 54, and a belt 56 to be measured. The belt transmission system 50 is used, for example, to drive automotive accessories. The natural-frequency measurement device 40 measures, in such a belt transmission system 50 in which a belt 56 is stretched between at least two pulleys 52, 54, the natural frequency of the belt 56 based on vibrations generated by hitting, with a hammer or a finger, a portion of the belt 56 stretched therebetween.

The acceleration sensor 48 is attached to the belt 56 to sense acceleration resulting from the vibration of the belt 56. The acceleration sensor 48 and the measuring instrument 30 are connected together via the communication cable 49 (such as a universal serial bus (USB)). The natural-frequency measurement device 40 measures the natural frequency of the belt 56 based on the acceleration sensed by the acceleration sensor 48. The natural frequency measured with the natural-frequency measurement device 40 is utilized as a piece of information for determining the tension of the belt 56 in the belt transmission system 50.

The acceleration sensor 48 is attached to an outer (upper) peripheral surface of a portion of the belt 56 stretched between the adjacent pulleys 52 and 54 in the belt transmission system 50 as illustrated in FIG. 2. A surface of the acceleration sensor 48 to be attached to the belt 56 is a repeatedly attachable adhesive surface made of, for example, a double-sided adhesive tape. Thus, the acceleration sensor 48 can be easily attached to the belt 56 by simply pressing the adhesive surface onto the surface of the belt 56.

This acceleration sensor 48 may be, for example, a digital output acceleration sensor that can sense acceleration perpendicular to the surface of the belt 56, or may be a triaxial acceleration sensor, for example. A capacitive-sensing micro-electromechanical system (MEMS) acceleration sensor is advantageously used as the acceleration sensor 48, because such a sensor can stably sense the acceleration.

The capacitive-sensing MEMS acceleration sensor 48 includes a sensing element section that senses the acceleration, and a signal processing circuit that amplifies and adjusts a signal from the sensing element section to output a resultant amplified and adjusted signal. The sensing element section is made of a stable substance such as silicon (Si), includes a sensor movable portion and a stationary portion, and senses the acceleration based on a variation in capacitance between the sensor movable portion and the stationary portion.

The acceleration sensor 48 does not have to be the capacitive-sensing MEMS acceleration sensor described above but may also be any suitable type of an acceleration sensor which uses a suitable sensing method, such as a piezoresistive MEMS acceleration sensor. The acceleration sensor 48 may also be any uniaxial or biaxial acceleration sensor as long as the sensor can sense the acceleration perpendicular to the surface of the belt 56.

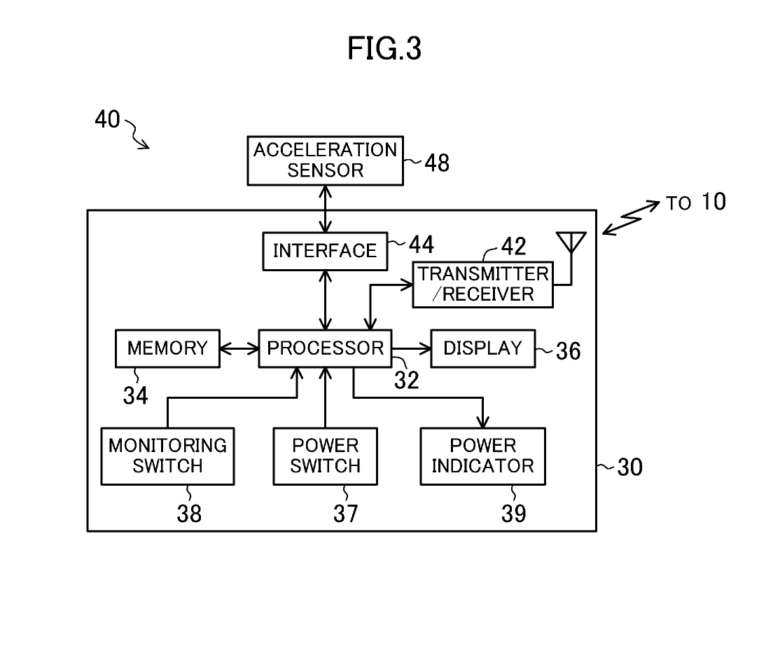

FIG. 3 is a block diagram illustrating an exemplary configuration for the natural-frequency measurement device 40 illustrated in FIG. 1. The natural-frequency measurement device 40 includes the measuring instrument 30 and the acceleration sensor 48. The measuring instrument 30 includes a processor 32, a memory 32, a display 36, a power switch 37, a monitoring switch 38, a power indicator 39, a transmitter/receiver 42, and an interface 44.

The measuring instrument 30 is a palmtop and flat one, and is easily portable because of its small size. An upper end of the measuring instrument 30 has a USB port (not shown), to which a USB connector (not shown) provided at one end of the communication cable 49 is connected. The interface 44 receives, via the USB port, the acceleration output from the acceleration sensor 48, converts the format of the signal received, and outputs the converted signal to the processor 32. On the front surface of the measuring instrument 30, arranged are the display 36, various switches such as the power switch 37 and the monitoring switch 38, and a status indicator lamp such as the power indicator 39. The display 36 may be a liquid crystal display to display the natural frequency of the belt 56 which has been measured. The power supply indicator 39 may be a light-emitting diode (LED) indicating whether the power supply is ON or OFF.

The processor 32 may be a digital signal processor (DSP) or a central processing unit (CPU), for example. The memory 34 may be an electrically erasable programmable read-only memory (EEPROM), for example. The memory 34 stores a program for measuring the natural frequency of the belt 56. The program includes a fast Fourier transform (FFT) computation program. The processor 32 is coupled not only to the memory 34 but also to the display 36, various switches such as the power switch 37 and the monitoring switch 38, and status indicator lamps such as the power indicator 39.

The processor 32 is configured to perform the processing of measuring the natural frequency of the belt 56 based on, for example, a signal supplied from the monitoring switch 38 and an acceleration signal input from the acceleration sensor 48 in accordance with the program read from the memory 34. The transmitter/receiver 42 transmits the natural frequency determined by the processor 32 to the calculator 10.

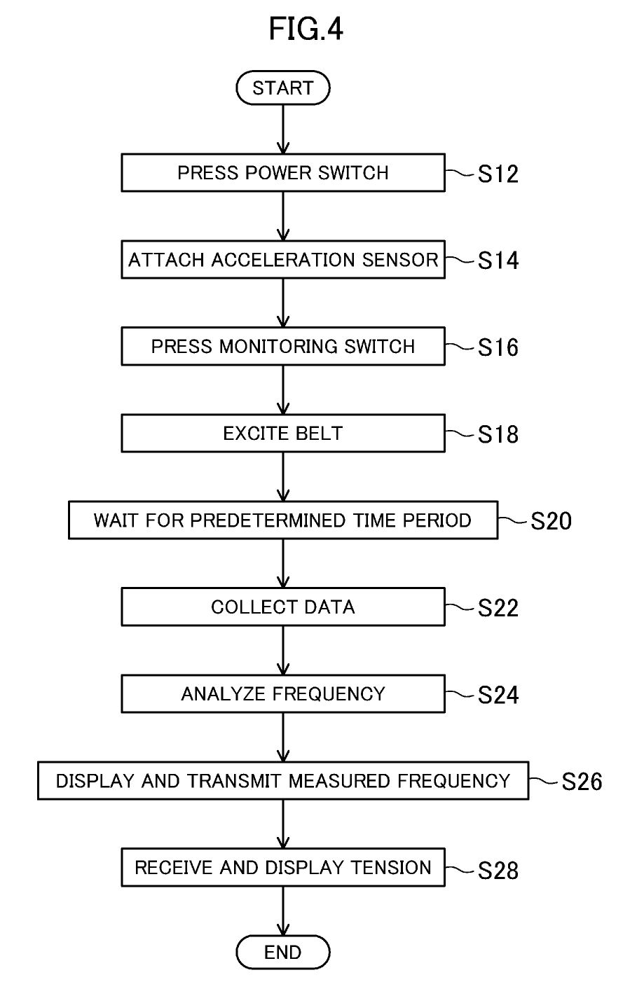

FIG. 4 is a flowchart showing an exemplary method for measuring the natural frequency of the belt 56 using the natural-frequency measurement device 40 illustrated in FIG. 3. In Block S12, a user presses the power switch 37 to turn ON the natural-frequency measurement device 40. When the power switch 37 is pressed, the processor 32 activates the measuring instrument 30, and lights the power indicator 39. The transmitter/receiver 42 establishes communications with the calculator 10. In Block S14, the user attaches the acceleration sensor 11 to a point, on the outer peripheral surface of the belt 56, which corresponds to a midpoint or approximate midpoint between the two pulleys 52 and 54 around which the belt 56 is stretched.

In Block S16, the user presses the monitoring switch 38. When the monitoring switch 38 is pressed, the processor 32 starts monitoring the acceleration signal input from the acceleration sensor 48, and monitors the vibration state of the belt 56. In Block S18, the user generates vibrations in the belt 56, for example, by hitting the belt 56 near its portion to which the acceleration sensor 48 is attached, i.e., a portion of the belt 56 located midway between the pulleys 52 and 54, with a hammer or by flipping that portion with a finger.

When acceleration greater than a predetermined degree of acceleration is sensed based on the acceleration signal input from the acceleration sensor 48, the processor 32 senses that the belt 56 has been hit, and then starts measuring the natural frequency of the belt 56. This prevents an unintentional start of measurement of the natural frequency before the belt 56 is hit, for example, in a situation where the acceleration sensor 48 is attached to the lower surface of the belt 56. Thus, the measurement of the natural frequency of the belt 56 can be started by accurately sensing a hit of the belt 56 as a trigger.

To prevent a subtle vibration of the belt 56, caused by a measuring operation or a measuring environment before the belt 56 is hit, from triggering an unintentional start of measurement of the natural frequency, such a predetermined degree of acceleration for determining a trigger to start measuring the natural frequency of the belt 56 is 2.0 G (where G represents the gravitational acceleration), for example, and is preferably greater than or equal to 3.0 G. Here, the predetermined degree of acceleration for determining such a trigger is set to be 3.0 G, for example. On sensing that the belt 56 has been hit, the processor 32 starts sampling the acceleration signal from the acceleration sensor 48. At this time, the sampling frequency is set to be, for example, about 3.2 kHz.

In Block S20, the processor 32 waits for about 80 milliseconds since the start of sampling of the acceleration signal, i.e., for a period of time necessary for sampling 256 points of acceleration data. Then, in Block S22, the processor 32 starts recording data, and collects acceleration data thus obtained by sampling the data over a period of time of, for example, 1280 milliseconds since this recording was started. In this case, the processor 32 stores 4096 points of acceleration data obtained by sampling.

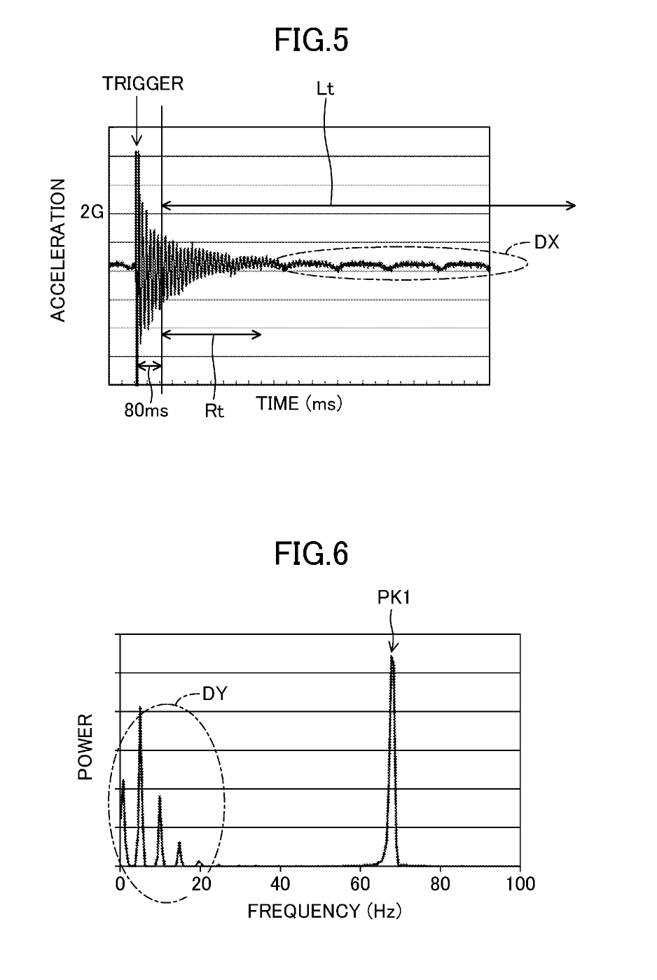

FIG. 5 is a graph showing an exemplary variation with time in acceleration resulting from vibration of the belt 56 that has been measured by the natural-frequency measurement device 40 illustrated in FIG. 3. The vibration of the belt 56 immediately after the hit contains too much noise components such as impact components generated by hitting the belt to provide data that is reliable enough to calculate the natural frequency of the belt 56 accurately. The noise components will attenuate with time, which allows the belt 56 to recover its vibration waveform with its natural frequency gradually.

The present inventors empirically discovered that the vibration of the belt 56 contained many noise components until about 80 milliseconds passed since the belt 56 had been hit. Thus, in this embodiment, the natural frequency of the belt 56 is measured except during the initial vibration period of the belt 56, which lasts 80 milliseconds since the belt 56 has been hit as described above.

FIG. 6 illustrates an exemplary power spectrum determined based on acceleration data in a situation where an acceleration signal was sampled over a relatively long period of time. The vibration of the belt 56 will attenuate more and more with time, and when its vibration has attenuated thoroughly, noise components that are not associated with the natural vibration of the belt 56 will be dominant over its weak vibration waveform (shown in the range DX in FIG. 5). In such a situation, the natural vibration of the belt 56 cannot provide data that is reliable enough to calculate the natural frequency of the belt 56 accurately.

If the acceleration signal is sampled over a relatively long period of time Lt including a time period in which the belt's vibration attenuates thoroughly, the power spectrum of the vibration frequency determined based on acceleration data obtained by sampling as will be described later tends to have peaks (within the range DY illustrated in FIG. 6) separately from the frequency PK1 of the natural vibration of the belt 56 as illustrated in FIG. 6.

The present inventors empirically discovered that the belt vibration turned into that weak and completely attenuated one with a low degree of reliability when about 1400 milliseconds passed since the belt 56 had been hit. Thus, in this embodiment, sampling the acceleration signal is stopped when 1280 milliseconds (the period of time Rt illustrated in FIG. 5) have passed since the signal started to be recorded, and the natural frequency of the belt 56 is measured except during the terminal vibration period in which the natural vibration is buried in noise.

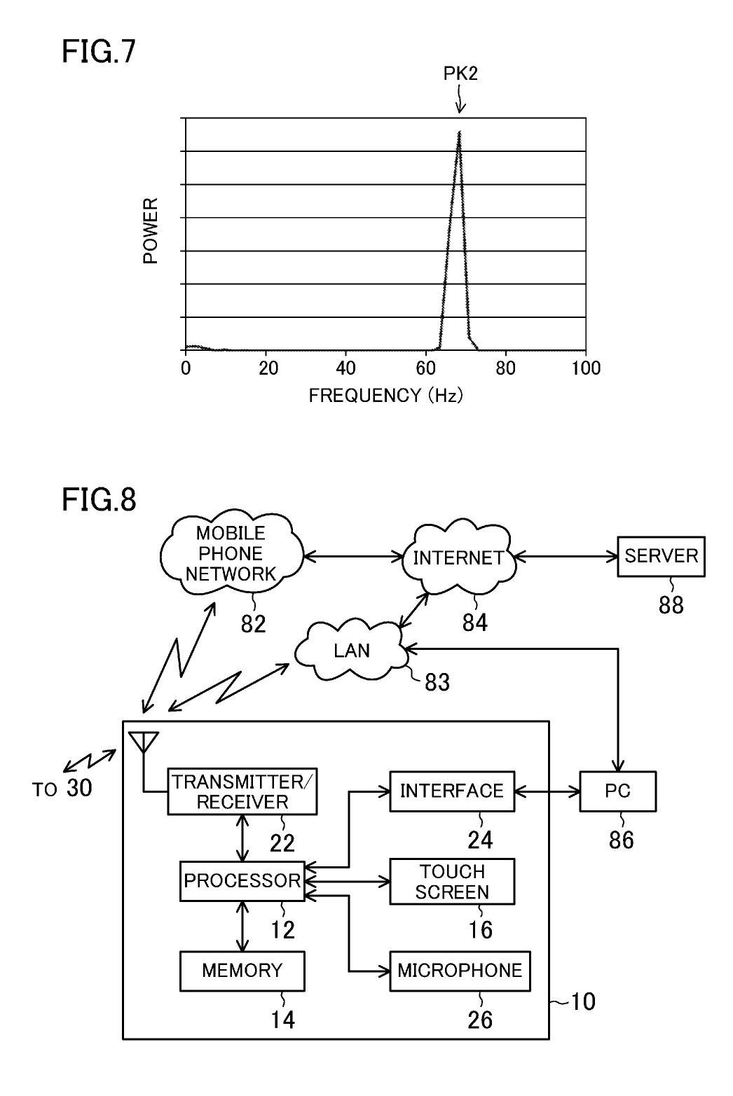

FIG. 7 illustrates an exemplary power spectrum determined based on acceleration data collected by the natural-frequency measurement device 40 illustrated in FIG. 3. In Block S24, the processor 32 performs frequency analysis of the collected acceleration data by FFT processing. Specifically, the processor 32 reads an FFT computation program from the memory 34 to run the program. In this processing, the processor 32 performs the FFT processing on the acquired acceleration data (4096 points of data) to obtain a power spectrum of the vibration such as the one shown in FIG. 6. Then, the processor 32 determines the vibration frequency corresponding to a peak PK2 of the power spectrum to be the natural frequency of the belt 56.

In this case, even if the power spectrum has a peak at a frequency of less than 10 Hz, the processor 32 will ignore that peak, and will determine the natural frequency in a frequency range of higher than or equal to 10 Hz. This is because the noise components that are not associated with the natural vibration of the belt 56 tend to be sensed in a low frequency range of less than 10 Hz. Thus, by determining the natural frequency in such a manner, the natural frequency of the belt 56 can be measured accurately.

In Block S26, the processor 32 outputs the measured natural frequency to the display 36 and the transmitter/receiver 42. The display 36 displays the measured natural frequency, and the transmitter/receiver 42 transmits the measured natural frequency to the calculator 10. The calculator 10 calculates the tension based on the natural frequency. This will be described later.

In Block S28, the transmitter/receiver 42 receives the tension or any other property value calculated by the calculator 10, and outputs the value to the processor 32. The processor 32 outputs the tension or any other property value to the display 36 to have the output data displayed there. Thus, the calculated tension is also displayed on the natural-frequency measurement device 40, thus enhancing the efficiency of the measurement operation. Note that the processing in Block S28 may be omitted.

In this manner, according to the natural-frequency measurement device 40 illustrated in FIG. 3, the natural frequency of the belt 56 is measured based on the acceleration sensed by the acceleration sensor 48 attached directly to the belt 56. This allows the acceleration sensor 48 to sense the vibration of the belt 56 directly. While a non-contact type natural-frequency measurement device including a microphone often allows the measurement results to be interfered by an external environmental factor such as background noise, this direct sensing prevents such interference, and also enables accurate sensing of low-frequency vibration. As such, without regard to whether the vibration of the belt 56 under measurement contains high-frequency components or low-frequency components, the natural frequency of the belt 56 under measurement can be measured accurately. Consequently, the natural frequency of the belt 56 can be accurately measured over a wide frequency range.

In addition, according to the natural-frequency measurement device 40, the natural frequency of the belt 56 is measured except during the initial vibration period of the belt 56 immediately after the hit and the terminal vibration period of the belt 56. The initial vibration contains many noise components that are not associated with the natural vibration. In the terminal vibration, the natural vibration of the belt 56 is buried in noise. Moreover, the natural frequency of the belt 56 is also determined by excluding frequency components of less than 10 Hz in which noise components tend to be sensed. As a result, the natural frequency of the belt 56 can be measured accurately.

In the foregoing description, the processor 32 measures the natural frequency of the belt 56 based on the acceleration data obtained for a period of time Rt of 1280 milliseconds after 80 milliseconds have passed since the belt 56 was hit. However, this is only an example of the present invention. For example, the acceleration data used to measure the natural frequency of the belt 56 may include data obtained before the passage of 80 milliseconds since the belt 56 was hit, or may include data obtained after the passage of 1280 milliseconds since the data collection was started.

—Calculator—

FIG. 8 is a block diagram illustrating an exemplary configuration for the calculator 10 illustrated in FIG. 1. The calculator 10 illustrated in FIG. 8 calculates the tension of the belt 56 based on the natural frequency measured by the natural-frequency measurement device 40 illustrated in FIG. 3. The calculator 10 further calculates an appropriate natural frequency of the belt corresponding to a target tension in a situation where the belt tension is adjusted, and displays the unit mass and recommended tension of the belt. In other words, the calculator 10 operates as, for example, a belt tension calculator and a belt natural-frequency calculator.

The calculator 10 illustrated in FIG. 8 includes a processor 12, a memory 14, a touch screen 16, a transmitter/receiver 22, an interface 24, and a microphone 26. The processor 12 transmits and receives data via, for example, the transmitter/receiver 22 or the interface 24. The transmitter/receiver 22 wirelessly transmits and receives data to and from an external network such as a mobile phone network 82. The interface 24 transmits and receives data to and from an external device such as a personal computer (PC) 86 via a communications link through wires. The communications link may be, for example, a universal serial bus (USB). The PC 86 is connected to a local area network (LAN) 83. The transmitter/receiver 22 may wirelessly transmit and receive data to and from the LAN 83.

The mobile phone network 82 and the LAN 83 are connected to a wide area network (WAN) such as the Internet 84. The transmitter/receiver 22 or the interface 24 is connected to a predetermined server 88 via, for example, the Internet 84. The processor 12 downloads a program, calculation data and other kinds of data from the server 88 to store the program and the data in advance in the memory 14.

Examples of the calculation data include the unit mass of the belt, the recommended tension thereof, a correction expression for correcting a theoretical expression, and the range within which the correction expression is applicable. The unit mass, the recommended tension, the correction expression, and the range within which the correction expression is applicable are prepared for each kind or each type of belt. The program includes a theoretical expression representing the relationship between the natural frequency and the tension. The calculation data and other kinds of data may be incorporated into the program.

The processor 12 may be, for example, a DSP or a CPU. The processor 12 loads the program from the memory 14 to run the program. The processor 12 outputs data of an image to be displayed to the touch screen 16. The touch screen 16 includes a display, and a touch sensor panel serving as an input device. Examples of the display include liquid crystal displays, and displays including organic electroluminescence (EL) devices (also referred to as “organic light-emitting diodes”). The touch sensor panel has a touch-sensitive surface, and may be substantially transparent. The touch sensor panel is arranged to cover the screen of the display at least partially. The touch screen 16 displays an image in accordance with data output from the processor 12. When a user touches the surface of the touch screen 16, data (e.g., the natural frequency of the belt and a span of the belt) is entered. The touch screen 16 outputs the entered data to the processor 12. The processor 12 performs a predetermined calculation based on the entered data, and outputs the result of calculation to the touch screen 16, which displays the result of calculation.

As can be seen from the foregoing description, the calculator 10 has a constituent section serving as a computer to run the program. This program instructs the calculator 10 to execute at least part of the processing to be described later. Typical examples of the calculators 10 include smartphones (advanced mobile phones), tablet PCs, and other kinds of PCs.

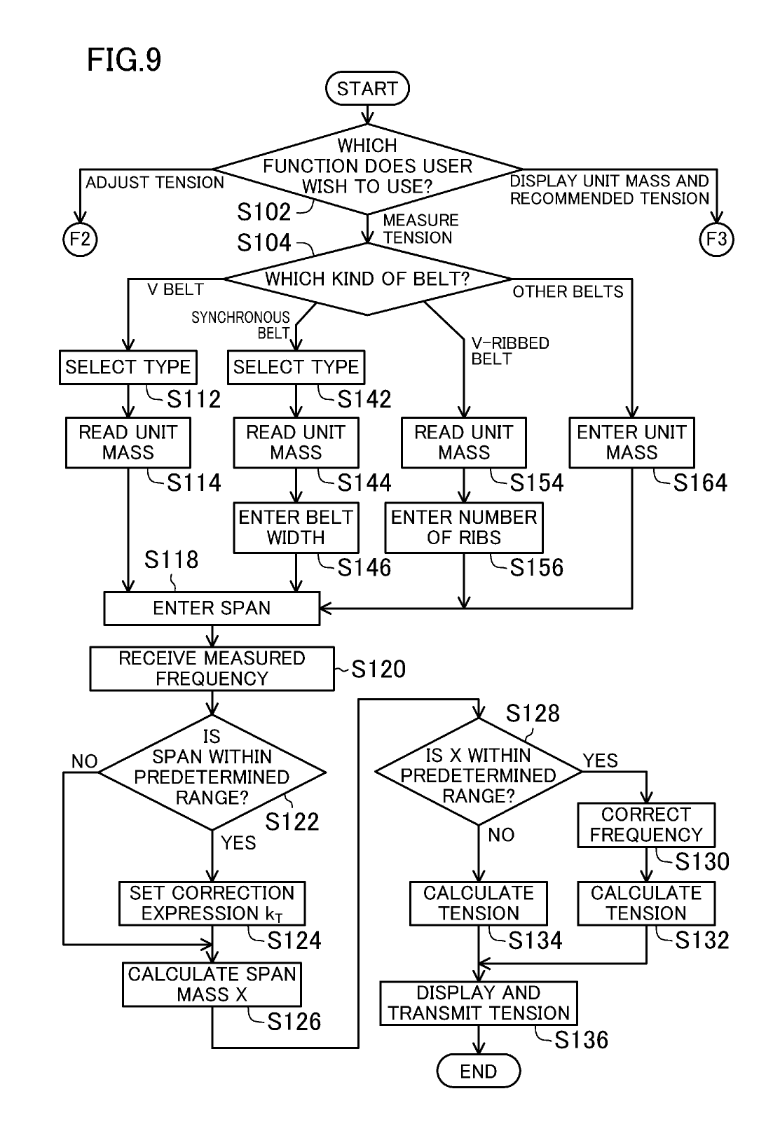

FIG. 9 is a flowchart showing an exemplary flow of processing to be performed by the calculator 10 illustrated in FIG. 8. The processing in the following flowcharts is performed, for example, by causing the processor 12 to execute the program loaded from the memory 14. In Block S102, the processor 12 displays, on the touch screen 16, a message asking the user a question. In this case, the message displayed there asks a question as to which of the following functions the user wishes to use: measuring the tension, adjusting the tension, or displaying the unit mass and the recommended tension of the belt. The user touches the touch screen 16 to select one of these functions. The processor 12 receives the user's choice from the touch screen 16. If the user has selected the function of measuring the tension, the process proceeds to Block S104. If the user has selected the function of adjusting the tension, the process proceeds to F2. If the user has selected the function of displaying the belt unit mass and the recommended tension, the process proceeds to F3.

In Block S104, the processor 12 displays, on the touch screen 16, a message asking the user a question about the kind of the belt. Examples of the kinds of belts include V belts, V-ribbed belts, synchronous belts, etc. The user touches the touch screen 16 to select the kind of the belt 56 from these kinds. The processor 12 receives the user's choice from the touch screen 16. If the user has selected a V belt, the process proceeds to Block S112. If the user has selected a synchronous belt, the process proceeds to Block S142. If the user has selected a V-ribbed belt, the process proceeds to Block S154. If the user has selected any other kind, the process proceeds to Block S164.

If the user has selected a V belt, the processor 12 displays, on the touch screen 16, a message asking the user a question about the type of the V belt in Block S112. The user touches the touch screen 16 to select the type of the belt 56. The processor 12 receives the user's choice from the touch screen 16. In Block S114, the processor 12 reads the unit mass μ of the selected type of the belt from the memory 14 in accordance with the kind and type of the belt. The unit of the unit mass μ is typically kilogram per meter (kg/m).

In Block S118, the processor 12 displays, on the touch screen 16, a message asking the user a question about the span L. The user touches the touch screen 16 to enter the span L of the belt 56. The touch screen 16 receives the span L, and the processor 12 receives the entered span L from the touch screen 16. The unit of the span L is typically meter (m).

In Block S120, the transmitter/receiver 22 receives the natural frequency fₘ of the belt 56 illustrated in FIG. 2, and outputs the received natural frequency fₘ to the processor 12. The natural frequency fₘ is a piece of information measured and transmitted by the natural-frequency measurement device 40 illustrated in FIG. 3 as described above.

In Block S122, the processor 12 reads from, for example, the memory 14, a piece of information indicating a predetermined span range corresponding to the belt under measurement and set for each kind of belt and for each type of belt. The processor 12 determines whether or not the entered span falls within such a predetermined range. If the span falls within the predetermined span range, the process proceeds to Block S124. Otherwise, the process proceeds to Block S126.

In Block S124, the processor 12 reads the coefficients of a tension correction expression k_{T} from the memory 14 in accordance with the kind and type of the belt to set the coefficients. The tension correction expression k_{T} is used to correct a predetermined computation expression so that the error caused by the belt bending stiffness is reduced. While the tension correction expression k_{T} is, for example, a linear expression of the span, the tension correction expression k_{T} may be a different type of expression. The tension correction expression k_{T} may vary according to the kind and type of the belt. In Block S124, the processor 12 may read the tension correction expression k_{T} from the memory 14 in accordance with the kind and type of the belt. In such a case, the predetermined span range in Block S122 depends on the kind and type of the belt.

The predetermined span range in Block S122 indicates the range within which the correction expression is applicable. If the entered span is outside of the predetermined span range, and thus, the operation in Block S124 is not performed, the process proceeds assuming that the value k_{T} is equal to one. The tension correction expression k_{T} will be described later.

In Block S126, the processor 12 calculates a span mass X based on the following expression.

X=μL (Expression 1)

In Block S128, the processor 12 determines whether or not the span mass X falls within a predetermined range. If the span mass X falls within the predetermined range, the process proceeds to Block S130. Otherwise, the process proceeds to Block S134.

If the natural frequency of the belt 56 is measured using the output of the acceleration sensor 57 attached to the belt 56, the measured natural frequency fₘ may be under the influence of the mass of the acceleration sensor 57. To overcome this problem, the measured natural frequency fₘ may be corrected by a frequency correction expression k_{f} that reduces that influence, and the result of the correction may be used as the natural frequency. In Block S130, the processor 12 corrects the measured natural frequency fₘ so that the influence of the mass of the acceleration sensor 57 is reduced based on, for example, the following expression.

fₐ=k_{f}fₘ (Expression 2)

The frequency correction expression k_{f} may be unchanged irrespective of the kind and type of the belt, or may be defined for each kind or type of belt or for each sensor mass of the acceleration sensor 57. If the frequency correction expression k_{f} is defined for each kind or type of belt or for each sensor mass, the processor 12 will read the frequency correction expression k_{f} corresponding to the belt 56 or the sensor mass from the memory 14, for example, in Block S130. In such a case, the predetermined range in Block S128 depends on the kind and type of the belt and the sensor mass. If the influence of the mass of the acceleration sensor 57 is not taken into account, the frequency correction expression k_{f} may be set to be one. The same applies hereafter. The frequency correction expression k_{f} will be described later.

In Block S132, the processor 12 calculates the belt tension using a predetermined expression for V belts. The calculation of the belt tension will be described. Generally, the relationship among the belt tension T₀ [N], the belt unit mass μ, the span L, and the natural frequency f [Hz] is represented by the following expression.

f=1/(2L)·(T₀/μ)^{1/2} (Expression 3)

Modification of this expression leads to the following theoretical expression for determining the tension based on the natural frequency:

T₀=4μL²f² (Expression 4)

In Block S132, the processor 12 corrects Expression 4 so that the error caused by the belt bending stiffness is reduced, and calculates the belt tension. Specifically, the processor 12 calculates the belt tension T using the following expression obtained by multiplying the tension T₀ determined by Expression 4 by the tension correction expression k_{T} corresponding to the belt 56.

T=4μL²fₐ²k_{T} (Expression 5)

Here, the corrected natural frequency fₐ is used as the natural frequency f.

Also in Block S134, as in Block S132, the processor 12 calculates the belt tension using the predetermined expression for V belts so that the error caused by the belt bending stiffness is reduced. Here, the processor 12 calculates the belt tension T based on the following expression using the measured natural frequency fₘ.

T=4μL²fₘ²k_{T} (Expression 6)

In this manner, Expressions 5 and 6 have been corrected by multiplying the tension correction expression k_{T} corresponding to the belt 56.

In Blocks S132 and S134, the processor 12 may determine the tension T₁ obtained by increasing the calculated tension T by a predetermined percentage or the tension T₂ obtained by decreasing the calculated tension T by a predetermined percentage. For example, if the measurement error is expected to be about 10%, the processor 12 may further determine the tension T₁ and/or the tension T₂ based on the following expressions.

T₁=1.1T

T₂=0.9T

The processor 12 may further determine the natural frequencies corresponding to these values.

In Block S136, the processor 12 outputs the tension T etc. determined in Block S132 or S134, the natural frequency fₘ that has already been measured, and other data to the touch screen 16 to display the output values. The touch screen 16 displays, for example, the tensions T, T₁, and T₂, the measured natural frequency fₘ, and the natural frequencies corresponding to the tensions T₁ and T₂. The processor 12 further outputs the tension T etc. determined in Block S132 or S134 to the transmitter/receiver 22. The transmitter/receiver 22 transmits the tension T etc. to the natural-frequency measurement device 40 illustrated in FIG. 3. The natural-frequency measurement device 40 receives the tension T etc., and displays the received value (Block S28 in FIG. 4).

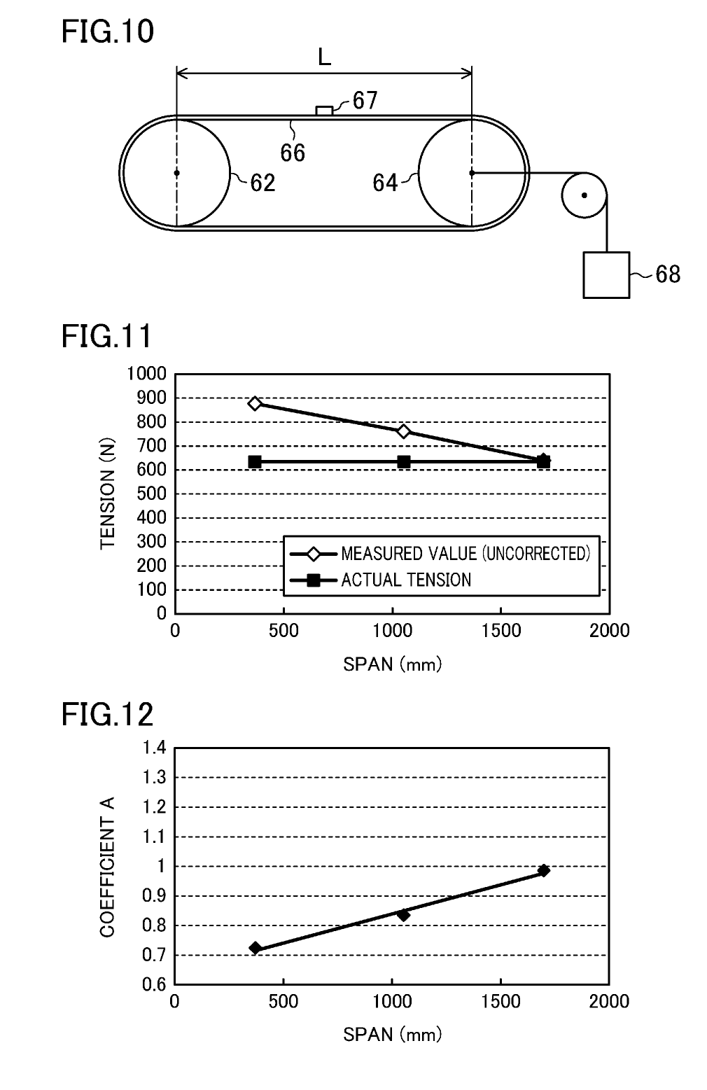

The tension correction expression k_{T} and an exemplary method for determining this expression will be described. FIG. 10 is a diagram illustrating an exemplary measurement device for determining the relationship between the tension and natural frequency of the belt. A belt 66 is looped between pulleys 62 and 64. The span L can be freely set. The shaft of the pulley 64 is movable, and the force of gravity of a weight 68 is applied to the shaft of the pulley 64 in a direction away from the pulley 62. The force applied to the shaft of the pulley 64 may be measured using, for example, a load cell. For example, a three-dimensional acceleration sensor 67 is attached to the belt 66. The device illustrated in FIG. 10 is used for various tests for belts, and permits a span L of several meters. That condition of use of the belt is close to the actual condition of use of the belt, and therefore, a correction expression can be determined more accurately.

In such a condition, the belt 66 is tapped with a hammer or any other tool, and the natural frequency of the belt 66 is measured based on the output of, for example, the acceleration sensor 67. Sound produced by the belt 66 may be received by a sensor, such as a microphone, and the natural frequency may be measured based on the output of the sensor. Processing is performed using the measured frequency in accordance with the flow in FIG. 9 to calculate the tension. In this calculation, the values of the correction expressions k_{T} and k_{f} are fixed at one. The tensions for some different spans are calculated in the same or similar way.

FIG. 11 is a graph showing an exemplary relationship between the span of one type of V belt and the measured tension thereof. While the actual tension is constant, the measured tension varies. In other words, that graph shows that the error of the tension varies according to the span.

FIG. 12 is a graph corresponding to the graph illustrated in FIG. 11 and showing an exemplary relationship between the span and a coefficient A. The ratio of each measured tension to the corresponding actual tension is determined. The inverse of the determined ratio is shown in the form of the coefficient A in FIG. 12. In other words, if the measured tension is multiplied by the coefficient A, the accurate tension is determined. Here, the relationship between the span L and the coefficient A in FIG. 12 is approximated by a linear function using, for example, a least-squares method. As a result, it can be seen that the coefficient A is obtained by the following expression:

A=0.20L+0.644

Thus, in the case of the belt used here in the measurement, the following expression is used as the tension correction expression in Blocks S132 and S134 in FIG. 9:

k_{T}=0.20L+0.644

Considering that the error of tension generally tends to increase as the span decreases, and taking the results shown in FIG. 11 into account, this expression would be applicable within a span range of less than or equal to 1700 mm. For this reason, in the case of the belt used here for the measurement, a determination is made whether or not the span is less than or equal to 1700 mm in Block S122 illustrated in FIG. 9. For other kinds or types of belts, the correction expressions and the range within which each correction expression is applicable may be determined in the same or similar way, and the expressions and ranges thus determined may be stored in the memory 14, or may be incorporated into the program. The generalized tension correction expression k_{T}, which is a linear expression of the span L, is illustrated as follows:

k_{T}=aL+b (Expression 7)

where a and b represent real constants.

Only in the case of some kinds and some types of belts, correction may be performed using the tension correction expression k_{T}. For example, for all types of V belts and some types of synchronous belts, Expression 7 may be used as the tension correction expression k_{T}, and for the other belts, the value k_{T} may be equal to one.

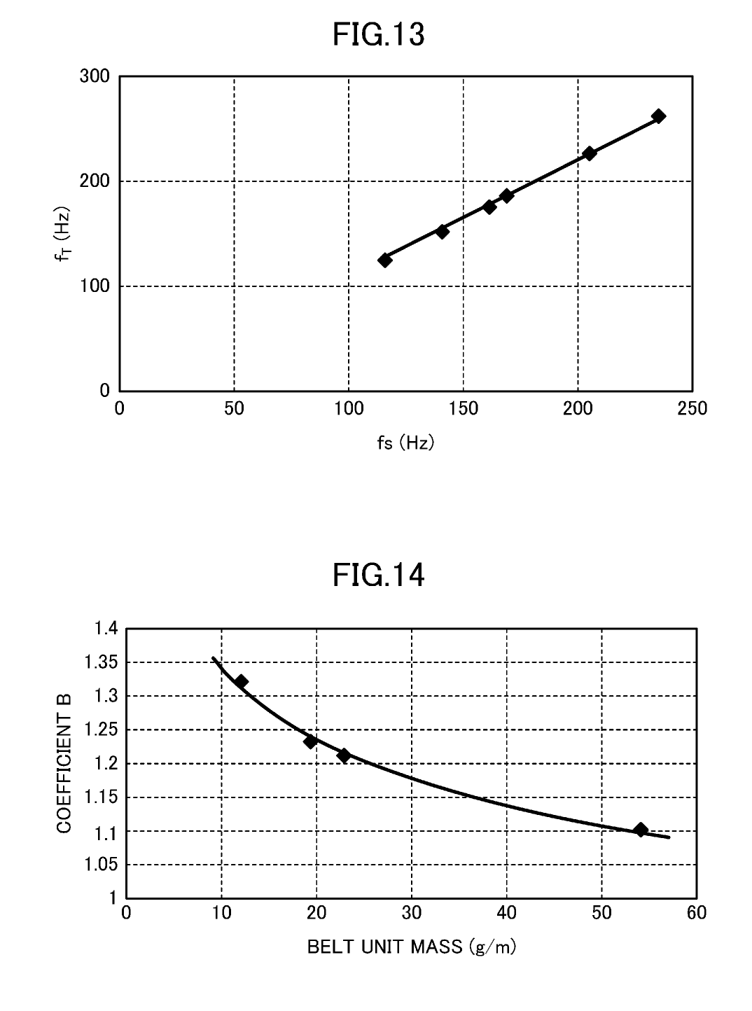

Next, the frequency correction expression k_{f} will be described. FIG. 13 is a graph showing an exemplary relationship between the natural frequency f_{S} of the belt determined by taking the mass of the acceleration sensor 57 into account and the theoretical natural frequency f_{T} of the belt. The theoretical natural frequency f_{T} has been determined without taking the mass of the acceleration sensor 57 into account. The natural frequency f_{S} of the belt has been determined by a finite element method using a three-dimensional beam element model. In determining the natural frequency, the density of a portion of the belt to which the acceleration sensor 57 is attached has been increased by a degree corresponding to the mass of the sensor. FIG. 13 shows the result obtained by varying the span and the tension in a situation where the sensor mass is 2 g and the unit mass of the belt is 54 g/m.

The following relationship between the natural frequency f_{S} and the natural frequency f_{T} is substantially obtained by the least-squares method:

f_{T}=Bf_{S}

In FIG. 13, the coefficient B is 1.1027. The coefficients B of belts, each having a different unit mass, are determined in the same or similar manner by calculation.

FIG. 14 is a graph showing an exemplary relationship between the unit mass of the belt and the coefficient B. Here, the relationship between the unit mass μ and the coefficient B in FIG. 14 is approximated by, for example, the least-squares method using an exponential function. As a result, it can be seen that the coefficient B is obtained based on the following expression:

B=1.76μ^{-0.12}

Thus, in the type of the belt used here for the measurement, the following expression is used as the frequency correction expression in Blocks S132 and S134 in FIG. 9.

k_{f}=1.76μ^{-0.12}

Analysis by a response surface methodology has showed that if the sensor mass is, for example, 2 g and if the span mass of the belt is greater than about 60 g, the error between the natural frequency f_{S} and the natural frequency f_{T} falls within about 3% irrespective of the span and the tension. Thus, this correction expression may be applied only to a situation where the span mass is less than 60 g. In this situation, in Block S128, the processor 12 determines whether or not the span mass X is less than 60 g. The correction expressions of other kinds and other types of belts, and the range within which each correction expression is applicable may be determined in the same or similar way, and then, may be stored in the memory 14, or may be included in the program. The correction expressions of other sensor masses, and the range within which each correction expression is applicable may also be determined in the same or similar way. The generalized frequency correction expression k_{f}, which is an exponential function of the unit mass u of the belt, is represented as follows:

k_{f}=cμ^{d} (Expression 8)

where c and d represent constants.

FIG. 9 will be referred to again. If the user has selected a synchronous belt, the processor 12 displays, on the touch screen 16, a message asking the user a question about the type of the synchronous belt in Block S142. The user touches the touch screen 16 to select the type of the belt 56. The processor 12 receives the user's choice from the touch screen 16. In Block S144, the processor 12 reads the unit mass σ of the selected type of belt from the memory 14 in accordance with the kind and type of the belt. The unit of the unit mass σ is typically kilogram per square meter (kg/m²).

In Block S146, the processor 12 displays, on the touch screen 16, a message asking the user a question about the belt width. The user touches the touch screen 16 to enter the width of the belt 56. The processor 12 receives the entered belt width W from the touch screen 16.

In the case of the synchronous belt, the processor 12 calculates the belt tension using a predetermined expression for synchronous belts in Blocks S132 and S134. In other words, the product of the unit mass σ and the belt width W is used instead of the unit mass μ in each of Expressions 5 and 6. Specifically, the following Expressions 9 and 10 are respectively used instead of Expressions 5 and 6 to calculate the tension.

T=4σWL²fₐ²k_{T} (Expression 9)

T=4σWL²fₘ²k_{T} (Expression 10)

The other operations are the same as or similar to those for the V belt.

If the user has selected a V-ribbed belt, the processor 12 reads the unit mass μᵣ (the mass of one rib per unit length) of the V-ribbed belt from the memory 14 in accordance with the kind of the belt in Block S154. The unit of the unit mass μᵣ is typically kilogram per meter (kg/m).

In Block S156, the processor 12 displays, on the touch screen 16, a message asking the user a question about the number of ribs of the belt 56. The user touches the touch screen 16 to enter the number of the ribs. The processor 12 receives the entered number n of the ribs from the touch screen 16.

In the case of the V-ribbed belt, the processor 12 calculates the belt tension using a predetermined expression for V-ribbed belts in Blocks S132 and S134. In other words, the product of the unit mass μᵣ and the number n of the ribs is used instead of the unit mass μ in each of Expressions 5 and 6. Specifically, the following Expressions 11 and 12 are respectively used instead of Expressions 5 and 6 to calculate the tension:

T=4nμᵣL²fₐ²k_{T} (Expression 11)

T=4nμᵣL²fₘ²k_{T} (Expression 12)

The other operations are the same as or similar to those for the V belt.

If the user has selected any other belt, the processor 12 displays, on the touch screen 16, a message asking the user a question about the unit mass of the belt in Block S164. The user touches the touch screen 16 to enter the unit mass of the belt 56. The processor 12 receives the entered unit mass μ from the touch screen 16. The unit of the unit mass μ is typically kilogram per meter (kg/m). In Blocks S132 and S134, the correction expression k_{T} is assumed to be equal to, for example, one. The other operations are the same as or similar to those for the V belt.

In this manner, the calculator 10 illustrated in FIG. 8 receives the natural frequency of the belt, and can thus determine the belt tension, no matter how the natural frequency is measured. If the span falls within a predetermined range corresponding to the belt, the tension correction expression corresponding to the belt reduces the error caused by the belt bending stiffness. If the span mass falls within a predetermined range corresponding to the belt, the frequency correction expression corresponding to the belt reduces the influence of the mass of the sensor for use in the measurement of the natural frequency. Thus, the tension of the belt can be determined more accurately. If the span and the span mass are outside of the predetermined ranges, no unnecessary correction is performed.

In the examples described above, in Blocks S102, S104, S112, S118, S142, S146, S156, and S164, the processor 12 displays, on the touch screen 16, a message asking the user a question about values etc. (namely, the function the user wishes to use, the kind of the belt, the type of the belt, the span L, the belt width, the number of ribs of the belt, and the unit mass of the belt), and the user touches the touch screen 16 to enter these values etc. However, this is only an example of the present invention. Optionally, in these blocks, the transmitter/receiver 22 may receive at least one of these values etc. from the natural-frequency measurement device 40, and may output them to the processor 12.

In this situation, the natural-frequency measurement device 40 includes a component such as a keypad, the processor 32 displays, on the display 36, a message asking the user a question about the function that the user wishes to use, the kind of the belt, the type of the belt, the span L, the belt width, the number of ribs of the belt, or the unit mass of the belt, and the user enters some of these values etc. via the component such as the keypad. The processor 12 may transmit a message asking the user a question about these values etc. via the transmitters/receivers 22 and 42 to the processor 32.

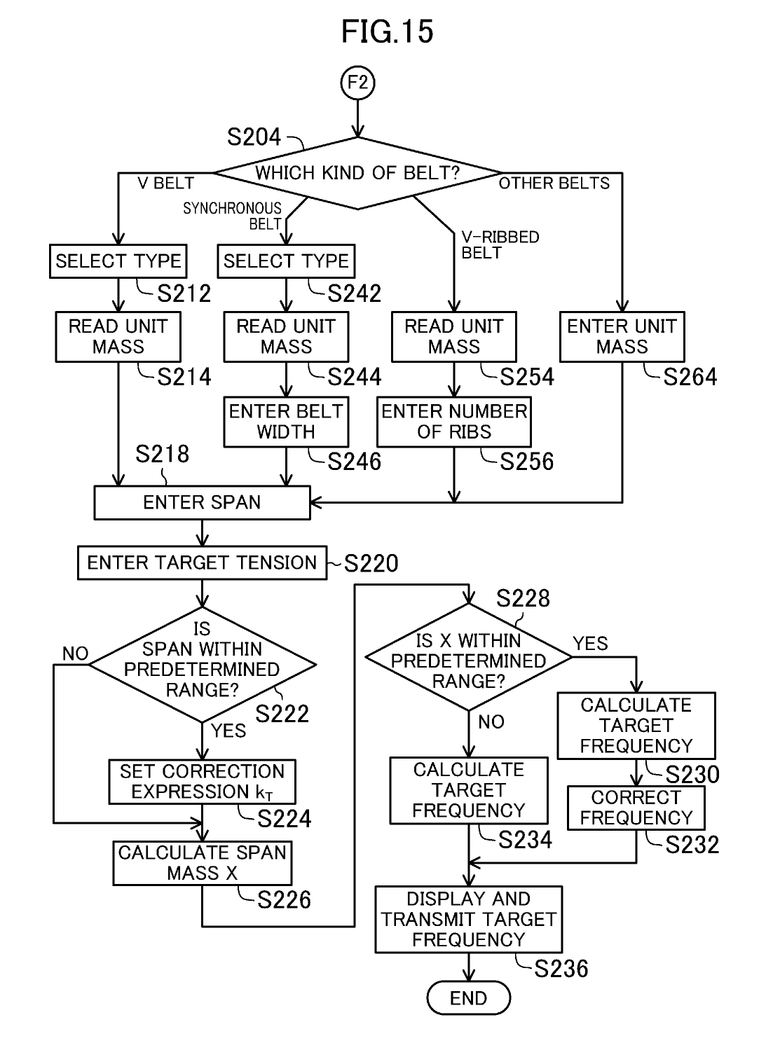

FIG. 15 is a flowchart illustrating an exemplary flow of processing in which the tension is adjusted by the calculator 10 illustrated in FIG. 8. In adjusting the tension, a natural frequency corresponding to the target tension (i.e., a target natural frequency) is determined. The operation in Block S204 is substantially the same as that in Block S104. If the user has selected a V belt, the process proceeds to Block S212. If the user has selected a synchronous belt, the process proceeds to Block S242. If the user has selected a V-ribbed belt, the process proceeds to Block S254. If the user has selected any other belt, the process proceeds to Block S264.

A situation where the user has selected a V belt will be described. The operations in Blocks S212, S214, and S218 are respectively the same as or similar to the ones in Blocks S112, S114, and S118 in FIG. 9.

In Block S220, the processor 12 displays, on the touch screen 16, a message asking the user a question about the target tension T of the belt. The user touches the touch screen 16 to enter the target tension T of the belt 56. The touch screen 16 receives the target tension T, and the processor 12 receives the entered target tension T from the touch screen 16. The operations in Blocks S222, S224, and S226 are respectively the same as or similar to the ones in Blocks S122, S124, and S126 in FIG. 9. If the operation in Block S224 is not performed, the process proceeds assuming that the value k_{T} is equal to one. In Block S228, the processor 12 determines whether or not the span mass X falls within a predetermined range. If the answer is YES, the process proceeds to Block S230. Otherwise, the process proceeds to Block S234.

In Block S230, the processor 12 calculates a natural frequency corresponding to the target tension of the belt (i.e., a target natural frequency). Modification of Expression 5 for V belts leads to the following expression:

fₐ=1/(2L)·(T/μk_{T})^{1/2} (Expression 13)

In Block S230, the processor 12 calculates the target natural frequency of the belt 56 by Expression 13.

In Block S232, the processor 12 corrects the determined natural frequency so that the influence of the mass of the acceleration sensor 57 is reduced, which is attached to the belt 56 to measure the natural frequency. Specifically, the processor 12 determines the target natural frequency fₘ by correcting, based on the following expression, the frequency fₐ that has already been determined:

fₘ=fₐ/k_{f} (Expression 14)

This expression is obtained based on Expression 2 described above.

Modification of Expression 6 for V belts leads to the following expression:

fₘ=1/(2L)·(T/μk_{T})^{1/2} (Expression 15)

In Block S234, the processor 12 calculates the target natural frequency of the belt 56 by Expression 15. Expressions 13 and 15 have been obtained by correcting Expression 3 for determining the natural frequency so that the error caused by the belt bending stiffness is reduced. This correction is performed by dividing Expression 3 by the square root of the tension correction expression k_{T} corresponding to the belt 56.

In Blocks S230 and S234, the processor 12 may obtain a target natural frequency f₁ by increasing the target natural frequency fₘ that has already been determined by a predetermined percentage or a target natural frequency f₂ by decreasing the target natural frequency fₘ by a predetermined percentage. For example, if a measurement error of about 10% is expected, the processor 12 may further obtain f₁ and/or f₂ by the following expression(s):

f₁=1.1fₘ

f₂=0.9fₘ

The processor 12 may further determine tensions corresponding to these values.

In Block S236, the processor 12 outputs the target natural frequency fₘ determined in Block S230 or S234, the entered target tension etc. to the touch screen 16 to display those values thereon. The touch screen 16 displays, for example, the target natural frequencies f, f₁, and f₂, the entered target tension, and the tensions corresponding to the target natural frequencies f₁ and f₂. Also, the processor 12 outputs, the target natural frequency fₘ determined in Block S230 or S234, the entered target tension etc. to the transmitter/receiver 22, which transmits the target natural frequency fₘ, the entered target tension etc. to the natural-frequency measurement device 40 illustrated in FIG. 3.

The natural-frequency measurement device 40 receives and displays the target natural frequency fₘ, the entered target tension etc. (Block S28 illustrated in FIG. 4). Thereafter, the user attaches the acceleration sensor 57 or any other appropriate sensor to the belt 56 to measure the natural frequency, and adjusts the belt tension so that the natural frequency becomes equal to, for example, the target natural frequency f. This allows the belt tension to be substantially equal to the target tension.

A situation where the user has selected a synchronous belt will be described. The operations in Blocks S242, S244, and S246 are respectively the same as or similar to the ones in Blocks S142, S144, and S146 in FIG. 9.

In the case of the synchronous belt, the processor 12 calculates the target natural frequency using a predetermined expression for synchronous belts in Blocks S230 and S234. Specifically, the following Expressions 16 and 17 may be respectively used instead of Expressions 13 and 15 to calculate the target natural frequency:

fₐ=1/(2L)·(T/σWk_{T})^{1/2} (Expression 16)

fₘ=1/(2L)·(T/σWk_{T})^{1/2} (Expression 17)

Expressions 16 and 17 are obtained by modifying Expressions 9 and 10, respectively. The other operations are the same as or similar to those for the V belt.

A situation where the user has selected a V-ribbed belt will be described. The operations in Blocks S254 and S256 are respectively the same as or similar to the ones in Blocks S154 and S156 in FIG. 9.

In the case of the V-ribbed belt, the processor 12 calculates the target natural frequency using a predetermined expression for V-ribbed belts in Blocks S230 and S234. Specifically, the following Expressions 18 and 19 are respectively used instead of Expressions 13 and 15 to calculate the target natural frequency:

fₐ=1/(2L)·(T/nμᵣk_{T})^{1/2} (Expression 18)

fₘ=1/(2L)·(T/nμᵣk_{T})^{1/2} (Expression 19)

Expressions 18 and 19 are obtained by modifying Expressions 11 and 12, respectively. The other operations are the same as or similar to those for the V belt.

A situation where the user has selected any other belt will be described. The operation in Block S264 is the same as or similar to that in Block S164 in FIG. 9. In Blocks S230 and S234, the correction expression k_{T} is assumed to be equal to, for example, one. The other operations are the same as or similar to those for the V belt.

As can be seen from the foregoing description, the calculator 10 illustrated in FIG. 8 can determine a target natural frequency corresponding to the target tension of the belt based on the target tension. While measuring the natural frequency of the belt, the user adjusts the tension of the belt so that the natural frequency of the belt becomes equal to the target natural frequency. Then, the belt tension can be adjusted to the target tension.

If the span falls within a predetermined range corresponding to the belt, the tension correction expression corresponding to the belt reduces the error caused by the bending stiffness of the belt. If the span mass falls within a predetermined range corresponding to the belt, the frequency correction expression corresponding to the belt reduces the influence of the mass of the sensor for use in the measurement of the natural frequency. Thus, the target natural frequency of the belt can be determined more accurately. If the span and the span mass are outside of their respective predetermined ranges, no unnecessary correction is performed.

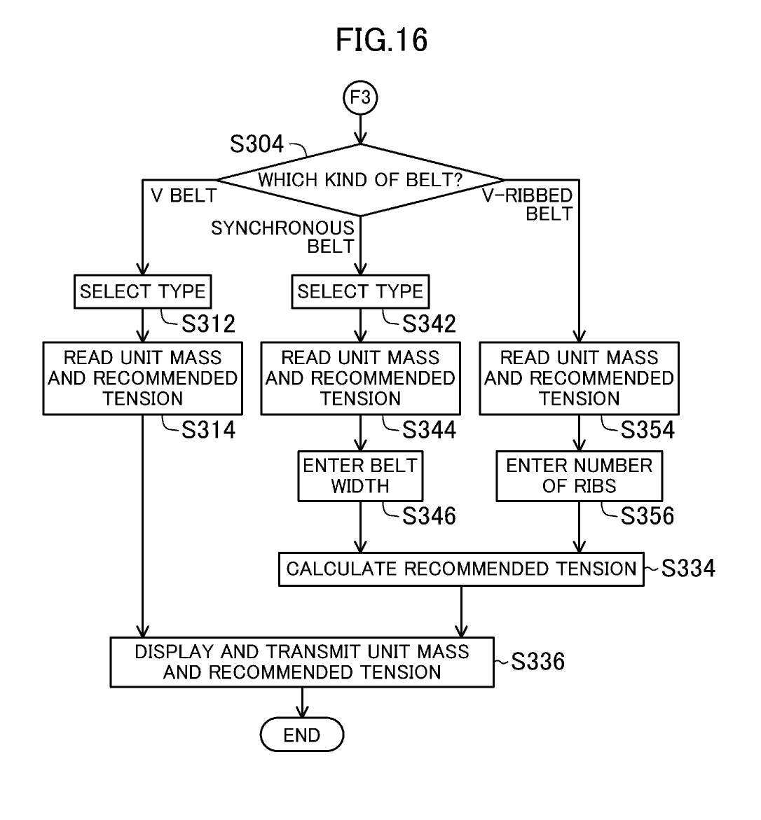

FIG. 16 is a flowchart showing an exemplary flow of processing in which the unit mass and recommended tension of the belt are displayed in the calculator 10 illustrated in FIG. 8. In Block S304, the processor 12 displays, on the touch screen 16, a message asking the user a question about the kind of belt. Examples of the kinds of belts include a V belt, a V-ribbed belt, and a synchronous belt. The user touches the touch screen 16 to select one of these kinds of belts. The processor 12 receives the user's choice from the touch screen 16. If the user has selected a V belt, the process proceeds to Block S312. If the user has selected a synchronous belt, the process proceeds to Block S342. If the user has selected a V-ribbed belt, the process proceeds to Block S354.

A situation where the user has selected a V belt will be described. The operation in Block S312 is the same as or similar to that in Block S112 in FIG. 9. In Block S314, the processor 12 reads the unit mass, recommended tension, etc. of the selected type of belt from the memory 14. In Block S336, the processor 12 outputs the unit mass, recommended tension, etc. that have been read to the touch screen 16. The touch screen 16 displays the unit mass, the recommended tension, etc. The processor 12 further outputs the unit mass, recommended tension, etc. that have been read to the transmitter/receiver 22, which transmits the unit mass, recommended tension, etc. that have been read to the natural-frequency measurement device 40 illustrated in FIG. 3. The natural-frequency measurement device 40 receives and displays the unit mass, recommended tension, and other pieces of information (Block S28 illustrated in FIG. 4).

A situation where the user has selected a synchronous belt will be described. The operations in Blocks S342 and S346 are respectively the same as or similar to the ones in Blocks S142 and S146 in FIG. 9. In Block S344, the processor 12 reads the unit mass of the selected type of belt and the recommended tension thereof per unit width from the memory 14. In Block S334, the processor 12 multiplies the recommended tension per unit width by the belt width to determine the recommended tension. The operation in Block S336 is the same as or similar to that for the V belt.

A situation where the user has selected a V-ribbed belt will be described. In Block S354, the processor 12 reads the unit mass of the belt and the recommended tension thereof per rib from the memory 14. The operation in Block S356 is the same as or similar to that in Block S156 in FIG. 9. In Block S334, the processor 12 multiplies the recommended tension per rib by the number of ribs to determine the recommended tension. The operation in Block S336 is the same or similar to that for the V belt.

In this manner, the calculator 10 illustrated in FIG. 8 allows the user to find the unit mass and recommended tension of the belt without referring to, for example, data for designing.

In the examples described above, in Blocks S204, S212, S218, S220, S242, S246, S256, and S264 illustrated in FIG. 15, and in Blocks S312, S342, S346, and S356 illustrated in FIG. 16, the processor 12 displays, on the touch screen 16, a message asking the user a question about values (namely, the kind of the belt, the type of the belt, the span L, the target tension T of the belt, the belt width, the number of ribs of the belt, and the unit mass of the belt) and the user touches the touch screen 16 to enter these values. However, this is only an example of the present invention. In these blocks, the transmitter/receiver 22 may receive at least one of these values from the natural-frequency measurement device 40, and may output it/them to the processor 12.

In this case, the natural-frequency measurement device 40 includes a component such as a keypad; the processor 32 displays, on the display 36, a message asking the user a question about the kind of the belt, the type of the belt, the span L, the target tension T of the belt, the belt width, the number of ribs of the belt, or the unit mass of the belt; and the user enters these values via the component such as the keypad. The processor 12 may transmit the message asking the user a question about these values via the transmitters/receivers 22 and 42 to the processor 32.

As can be seen from the foregoing description, the system illustrated in FIG. 1 employs an acceleration sensor, which enables accurate measurement of the natural frequency of the belt over a wide frequency range. Moreover, the belt tension can be determined accurately at a low cost, because a general-purpose calculator (such as a smartphone), which many users should already have, is used.

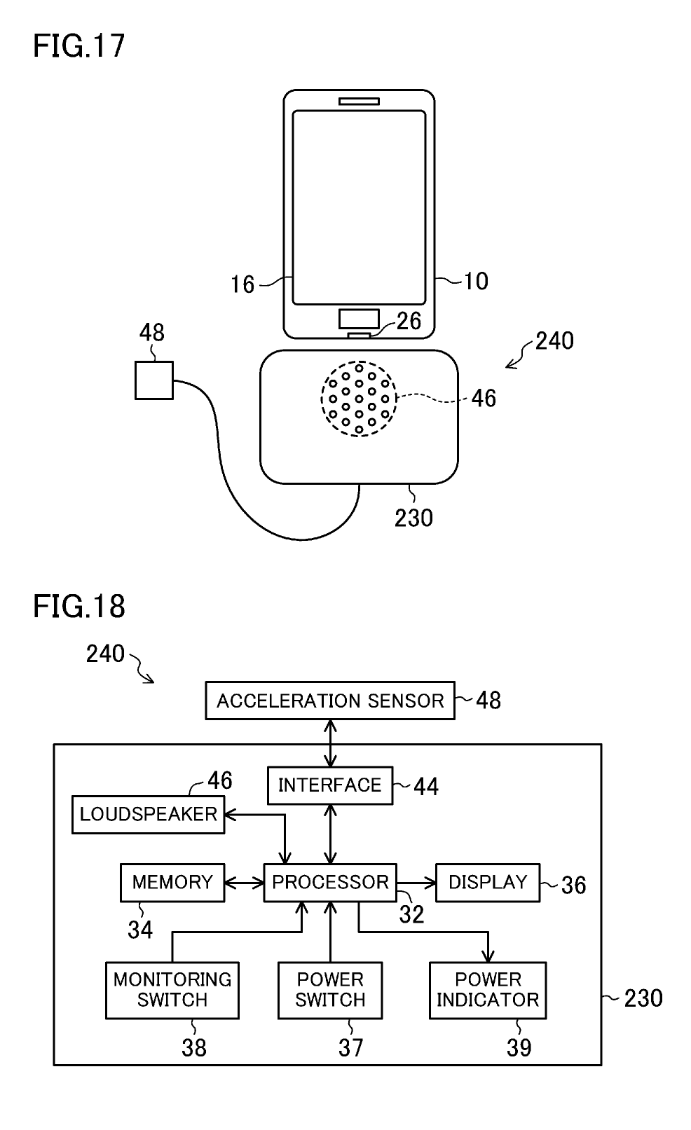

FIG. 17 is a conceptual diagram illustrating another example of the system illustrated in FIG. 1. The system illustrated in FIG. 17 includes a natural-frequency measurement device 240 and a calculator 10. This system transmits information between the natural-frequency measurement device 240 and the calculator 10 as sound waves without conducting wireless communications.

FIG. 18 is a block diagram illustrating an exemplary configuration for the natural-frequency measurement device 240 illustrated in FIG. 17. The natural-frequency measurement device 240 has the same configuration as the natural-frequency measurement device 40 illustrated in FIG. 3 except that the transmitter/receiver 42 is replaced by a loudspeaker 46. For example, as illustrated in FIG. 17, the natural-frequency measurement device 240 has, on its back surface, the loudspeaker 46, which is arranged in the vicinity of a microphone 26 of the calculator 10. The loudspeaker 46 may be brought into close contact with the microphone 26 of the calculator 10.

The natural-frequency measurement device 240 performs the operations illustrated in FIG. 4. Note that in Block S26, the processor 32 outputs information about the measured frequency through the loudspeaker 46 as sound waves. The operation in Block S28 is not performed. For example, the sound wave may have the same frequency as the measured frequency; or may have a frequency that satisfies a predetermined relationship between the measured frequency and the frequency of the sound wave to be output, and that corresponds to the measured frequency. The processor 32 may encode information about the measured frequency, and may modulate a sound wave having a predetermined frequency based on the code thus obtained. The system illustrated in FIG. 17 does not need to conduct wireless communications, resulting in a reduction in the cost of the natural-frequency measurement device 240.

In Block S120 illustrated in FIG. 9, the user may touch the touch screen 16 to enter the natural frequency fₘ measured by the natural-frequency measurement device 40, and the processor 12 may receive the entered natural frequency fₘ from the touch screen 16.

The processor 12 may make the memory 14 store data entered via the touch screen 16, data received from the natural-frequency measurement device 40 or 240, and data displayed on the touch screen 16, and may display, on the touch screen 16, any of these data upon request from the user. The processor 32 may also make the memory 34 store data transmitted to, and received from, the calculator 10 and data displayed on a display 36, and may display, on the display 36, any of these data upon request from the user.

Each functional block herein can be typically implemented by hardware. For example, each functional block may be implemented on a semiconductor substrate as a part of an integrated circuit (IC). Here, examples of the ICs include large-scale integrated circuits (LSIs), application-specific integrated circuits (ASICs), gate arrays, and field programmable gate arrays (FPGAs). Alternatively, a part or all of each functional block may also be implemented by software. For example, such a functional block may be implemented as a combination of a processor and a program executed by the processor. In other words, each functional block described herein may be implemented by hardware alone, by software alone, or as any arbitrary combination of hardware and software.

When the above-described process is implemented by software, microcodes, assembly language codes, or higher-level language codes, for example, may be used. The codes may be stored in one or more volatile or nonvolatile non-transitory computer-readable storage media. Examples of those non-transitory computer-readable storage media include random access memories (RAMs), read only memories (ROMs), electrically erasable programmable read only memories (EEPROMs), flash memories, magnetic storage media, and optical storage media. Embodiments within the scope of the present invention may also include such non-transitory computer-readable storage media.

The many features and advantages of the present invention are apparent from the written description, and thus, it is intended by the appended claims to cover all such features and advantages of the present invention. Further, since numerous modifications and changes will readily occur to those skilled in the art, it is not desired to limit the present invention to the exact construction and operation illustrated and described. Hence, all suitable modifications and equivalents may be resorted to, falling within the scope of the invention.

As can be seen from the foregoing description, the present invention is useful, for example, as a natural-frequency measurement device, a method for belt-tension calculation, a method for belt natural-frequency calculation, and a non-transitory computer-readable storage medium containing instructions which performs one of the methods above.

What is claimed is:

1. A natural-frequency measurement device for measuring, in a belt transmission system including at least two pulleys between which a belt is stretched, a natural frequency of the belt based on a vibration generated by hitting a portion of the belt stretched between two adjacent ones of the at least two pulleys, the device comprising:
an acceleration sensor attached to the portion of the belt to sense acceleration resulting from the vibration of the belt; and
a measuring instrument configured to measure the natural frequency of the belt based on the acceleration sensed by the acceleration sensor, wherein
the measuring instrument transmits the natural frequency to a belt-tension calculator which determines a tension of the belt based on the natural frequency.

2. The natural-frequency measurement device of claim 1, wherein
the measuring instrument receives and displays the tension of the belt calculated by the belt-tension calculator.

3. The natural-frequency measurement device of claim 1, wherein
the measuring instrument includes an input device, and transmits, to the belt-tension calculator, a span of the belt and the kind or type of the belt which are entered via the input device.

4. The natural-frequency measurement device of claim 1, wherein
the measuring instrument wirelessly transmits the natural frequency.

5. The natural-frequency measurement device of claim 1, wherein
the measuring instrument transmits the natural frequency as sound waves.

6. The natural-frequency measurement device of claim 1, wherein
the measuring instrument receives, from a belt natural-frequency calculator configured to determine a target natural frequency of the belt, the target natural frequency, and displays the received target natural frequency.

7. The natural-frequency measurement device of claim 6, wherein
the measuring instrument includes an input device, and transmits, to the belt natural-frequency calculator, a target tension of the belt, a span of the belt, and the kind or type of the belt which are entered via the input device.

8. A non-transitory computer-readable storage medium containing instructions which, when executed by one or more processors, performs a method for belt-tension calculation, the method comprising:
receiving a span of a belt and the kind or type of the belt;
receiving, from a natural-frequency measurement device configured to measure a natural frequency of the belt, the natural frequency;
correcting a predetermined expression so that an error caused by a bending stiffness of the belt is reduced if the span falls within a predetermined range corresponding to the belt;
determining a tension of the belt, based on the natural frequency, the span, and a unit mass of the belt read from a memory, by using the corrected expression; and
displaying the determined tension on a display.

9. The non-transitory computer-readable storage medium of claim 8, the method further comprising:
transmitting the determined tension to the natural-frequency measurement device.

10. The non-transitory computer-readable storage medium of claim 8, wherein
the receiving the span of the belt and the kind or type of the belt includes receiving the span of the belt and the kind or type of the belt from the natural-frequency measurement device.

11. A non-transitory computer-readable storage medium containing instructions which, when executed by one or more processors, performs a method for belt natural-frequency calculation, the method comprising:
receiving a target tension of a belt, a span of the belt, and the kind or type of the belt;
correcting a predetermined expression so that an error caused by a bending stiffness of the belt is reduced if the span falls within a predetermined range corresponding to the belt;
determining a target natural frequency of the belt, based on the target tension, the span, and a unit mass of the belt read from a memory, by using the corrected expression;
displaying the determined target natural frequency on a display; and
transmitting the determined target natural frequency to a natural-frequency measurement device configured to measure a natural frequency of the belt.

12. The non-transitory computer-readable storage medium of claim 11, wherein
the receiving the target tension of the belt, the span of the belt, and the kind or type of the belt includes receiving the target tension of the belt, the span of the belt, and the kind or type of the belt from the natural-frequency measurement device.

13. A method for calculating a tension of a belt, the method comprising:
receiving a span of the belt and the kind or type of the belt;
receiving, from a natural-frequency measurement device configured to measure a natural frequency of the belt, the natural frequency;
correcting a predetermined expression so that an error caused by a bending stiffness of the belt is reduced if the span falls within a predetermined range corresponding to the belt;
determining a tension of the belt, based on the natural frequency, the span, and a unit mass of the belt read from a memory, by using the corrected expression; and
displaying the determined tension on a display.

14. A method for calculating a natural frequency of a belt, the method comprising:
receiving a target tension of the belt, a span of the belt, and the kind or type of the belt;
correcting a predetermined expression so that an error caused by a bending stiffness of the belt is reduced if the span falls within a predetermined range corresponding to the belt;
determining a target natural frequency of the belt, based on the target tension, the span, and a unit mass of the belt read from a memory, by using the corrected expression;
displaying the determined target natural frequency on a display; and
transmitting the determined target natural frequency to a natural-frequency measurement device configured to measure the natural frequency of the belt.
